(19) United States
(12) Patent Application Publication
(10) Pub. No.: US 2007/0239584 A1
(43) Pub. Date: Oct. 11, 2007

(54) Creating or redeeming shares of an exchange-traded fund

(76) Inventors: Stuart Evan Fross, Concord, MA (US); Ian P. Johnson, Westborough, MA (US)

Correspondence Address: FISH & RICHARDSON PC, P.O. BOX 1022, MINNEAPOLIS, MN, 55440-1022, US

(21) Appl. No.: 11/401,497

(22) Filed: Apr. 7, 2006

(51) Int. Cl. G06Q 40/00

(52) U.S. Cl. 705/36 R

(57) ABSTRACT

Selling exchange-traded fund (“ETF”) shares by an investment company receiving a pre-determined group of financial assets from an authorized participant in exchange for a number of ETF shares, the number of ETF shares corresponding to the group of financial assets, and the investment company purchasing a number of shares of an underlying fund, the number of shares corresponding to the group of financial assets. Redeeming ETF shares with an investment company holding a number of shares of an underlying fund by receiving ETF shares from an authorized participant, and redeeming the number of shares of the underlying fund for a first group of financial assets; obtaining a second group of financial assets; and transferring the second group of financial assets to the authorized participant.

### BACKGROUND OF THE INVENTION

A mutual fund is an open-end investment company that holds a portfolio of securities, and an investor may invest in an undivided interest in the portfolio by buying shares of the mutual fund. The mutual fund can be actively managed by a manager or a group of managers. The management uses its (collective) judgment in deciding which securities to include in the fund's portfolio from day to day. In this case, the management typically is under a fiduciary duty to keep confidential the actual portfolio of securities held by the fund, except in circumstances disclosed in the fund's prospectus. In contrast, a non-actively managed mutual fund can be an index fund. The portfolio of securities of such funds can be chosen to match a published index of securities, such as Standard & Poor's 500 Index (“S&P 500”). In this case, the actual portfolio of the mutual fund is typically known, or a representative portfolio is frequently made publicly available.

The value of a mutual fund is determined by the value of its portfolio of securities. One typical valuation is the net asset value (“NAV”) per share of the fund. The NAV is defined to be the total fund assets minus total fund liabilities, divided by the total number of outstanding shares. A mutual fund is required to calculate and publish its NAV each business day. Other valuations include the fund's holdings' net or average value, and the fund's holdings' net or average performance (i.e., change in value) over a pre-determined time. Still other valuations are possible.

A shareholder of a mutual fund is effectively prohibited by §22(d) of the Investment Company Act of 1940 (“the '40 Act”) from selling his shares through a market participant (i.e., a broker-dealer or an exchange member firm) on a secondary market, such as on an exchange or over the counter. Instead, a shareholder who desires to purchase more shares or sell his existing shares must purchase or redeem them directly with the mutual fund. Typically, the mutual fund may either pay money to the redeeming shareholder in an amount equal to the next-published NAV per share redeemed, or may give the shareholder a slice of the fund's portfolio of securities proportional to the value of shares redeemed (where, again, the shares and portfolio securities are valued according to the fund's next-published NAV). The latter scenario is referred to as a “redemption in kind.” It is often the case that redemptions-in-kind are effectuated on a “pro-rata” basis, particularly when the redeeming shareholder is an “affiliate.” A shareholder typically gains affiliate status by owning 5% or more of the mutual fund.

An exchange traded fund (“ETF”) is a type of fund that can share characteristics of both mutual funds and other exchange traded assets like stocks. Like a mutual fund, an exchange traded fund can derive its value from a portfolio of securities. For example, one well-known ETF is Standard & Poor's Depositary Receipts™ (“SPDR™”). It derives its value from the portfolio of securities described by the S&P 500 index.

An ETF is a desirable investment for several reasons. First, it allows an investor to achieve relatively large diversity of investment holdings for relatively little cost. For example, if an ETF derives its value from a portfolio of 500 stocks, then a single share of the ETF benefits from the diversity of the 500 stocks, yet the price of a single ETF share is usually much less than the total cost of one share of each of the 500 stocks. Second, by virtue of an exemptive order granted by the Securities and Exchange Commission and no-action relief provided by its staff, shares of an ETF may be traded in a secondary market, unlike shares of a mutual fund. There are other advantages associated with ETFs.

### SUMMARY OF THE INVENTION

In general, in one aspect, selling ETF shares includes: receiving, by an investment company, a pre-determined group of financial assets from an authorized participant in exchange for a number of ETF shares, the number of ETF shares corresponding to the group of financial assets; and purchasing a number of shares of an underlying fund, the number of shares corresponding to the group of financial assets.

Implementations may include one or more of the following features. The group of financial assets includes currency. The group of financial assets includes securities. Selling ETF shares also includes selling the group of financial assets for currency, and the number of shares of the underlying fund is purchased with the currency. The underlying fund includes holdings, and the securities are determined to correspond to the underlying fund's holdings. The underlying fund includes holdings having a net performance over a defined period, and the securities are chosen to correspond to the fund's holdings' net performance over the defined period. The underlying fund has a net performance over a defined period, and the securities are chosen to correspond to the fund's net performance over the defined period. The investment company is a unit investment trust. The investment company is a management investment company. The investment company is a face-amount certificate company. The fund is actively managed. The fund is an index fund. The fund is open-ended. The fund is closed-ended. Selling is performed in at most one business day.

In general, in another aspect, redeeming ETF shares includes: receiving, by an investment company holding a number of shares of an underlying fund, ETF shares from an authorized participant; redeeming the number of shares of the underlying fund for a first group of financial assets; obtaining a second group of financial assets; and transferring the second group of financial assets to the authorized participant.

Implementations may include one or more of the following features. The first group of financial assets includes currency. The first group of financial assets includes securities. The second group of financial assets includes currency. The second group of financial assets includes securities. Obtaining the second group of financial assets includes purchasing the securities with a quantity of currency obtained from the first group of financial assets. The fund includes holdings, and the securities in the second group of financial assets correspond to the fund's holdings. The fund includes holdings having a net performance, and the securities in the second group of financial assets correspond to the fund's holdings' net performance. The investment company is a unit investment trust. The investment company is a management investment company. The investment company is a face-amount certificate company. The fund is actively managed. The fund is an index fund. The fund is open-ended. The fund is closed-ended. Redeeming is performed in at most one business day.

In general, in another aspect, selling ETF shares includes: transferring, from an investment company, a number of ETF shares to an authorized participant in response to receiving a number of shares of an underlying fund from the underlying fund, in which the underlying fund transfers the number of shares to the investment company in response to the authorized participant transferring a group of financial assets to the underlying fund.

In general, in another aspect, redeeming ETF shares includes: redeeming a number of shares of an underlying fund held by an investment company in response to receiving, by the investment company, a number of ETF shares from an authorized participant, in which the underlying fund transfers a group of financial assets to the authorized participant in response to the investment company redeeming shares of the underlying fund.

Other aspects include other combinations of the features recited above and other features, expressed as methods, apparatus, systems, program products, and in other ways. Other features and advantages will be apparent from the description and from the claims.

Certain implementations may have one or more of the following advantages. A mutual fund and an ETF with common investment portfolios can be implemented simultaneously. ETF-related transaction costs can be isolated and paid for by ETF investors, while transaction costs shared by ETF investors and investors in the underlying mutual fund can be shared. The preferred medium of exchange between an authorized participant and the investment company can be determined independently of the preferred medium of exchange between the investment company and the underlying fund.

### BRIEF DESCRIPTION OF THE DRAWINGS

FIG. 1 shows a schematic view of an investment company and its underlying fund.

FIG. 2A shows a flow chart for creating ETF shares in money transactions.

FIG. 2B shows flow chart for creating ETF shares in non-money transactions.

FIG. 3A shows a flow chart for redeeming ETF shares for money.

FIG. 3B shows an alternative flow chart for redeeming ETF shares for money.

FIG. 3C shows a flow chart for redeeming ETF shares for non-money.

FIG. 3D shows an alternative flow chart for redeeming ETF shares for non-money.

FIG. 4A shows a circular arrangement for creating ETF shares.

FIG. 4B shows a circular arrangement for redeeming ETF shares.

FIGS. 5A and 5B show a schematic view of a system for creating or redeeming ETF shares.

### DETAILED DESCRIPTION OF THE PREFERRED EMBODIMENTS

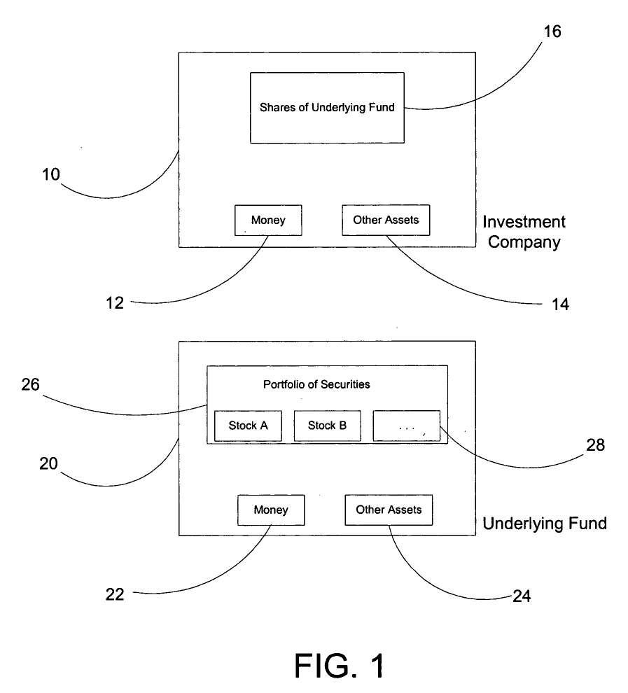

With reference to FIG. 1, an investment company 10, as defined in §3(a) of the Investment Company Act of 1940 ('40 Act), is shown. The investment company 10 may hold a relatively small amount of money 12 or other assets 14 necessary for its day to day activities (e.g., necessary equipment to transact business and sufficient money to cover transaction costs), but the remaining assets that constitute “investment securities” under §12(d)(1)(E) of the '40 Act are limited, subject to exemptive relief by the SEC, to securities 16 issued by a second investment company. In the context in which the second investment company is a mutual fund, the second investment company is referred to as the “underlying fund” 20 of the investment company.

The investment company may be a unit investment trust (“UIT”), a management company, or a face-amount certificate company as those terms are defined in §4 of the Investment Company Act of 1940.

In addition to a relatively small amount of money 22 and other assets 24 necessary for its day to day activities, the underlying fund 20 holds a portfolio of securities 26. For purposes of illustration, the underlying fund 20 of FIG. 1 has a portfolio of securities 26 that includes stock A, stock B, and other stocks 28. In practice, the portfolio of securities 26 of a mutual fund may include any number of different securities, or other instruments of any kind whatsoever, such as futures contracts, options, swaps, or other derivatives.

The investment company 10 issues securities that can be purchased directly from the investment company 10 (explained more fully below), or can be traded on a secondary market such as a stock exchange or over the counter. The securities derive their value from the value of the underlying fund 20: e.g., it is typically expected that the correlation in the increase in value of the investment company 10 will directly correspond to the increase in value of the underlying fund 20. The value of the underlying fund is ultimately determined by market forces such as supply and demand. The investment company 10 is called an Exchange Traded Fund (“ETF”) because its shares can be traded on a stock exchange or in a similar secondary market, and the shares derive their value from the underlying fund 20 by their price in the secondary market. Shares of such an investment company 10 are called ETF shares.

Only “authorized participants” may transact directly with the investment company 10 to purchase or redeem ETF shares. An authorized participant is an entity chosen by the investment company 10 to undertake the responsibility of obtaining the assets needed to create ETF shares. Authorized participants also may make markets in the ETF shares for their own account, or may act as agent or principal with respect to transactions on behalf of their customers. In principle, any entity can be an authorized participant, but typically authorized participants are large institutional organizations, for example, market makers or specialists who have obtained the requisite regulatory approval to act in one or both of these capacities. Once an authorized participant receives ETF shares, the authorized participant may trade those shares on a secondary market.

In an exemplary embodiment, the investment company 10 only creates or redeems ETF shares in collections of a certain size. A collection of this size is called a creation unit. Creation units are typically 50,000 shares, but in principle may be any size.

Authorized participants may transact with the investment company 10 using money (or more generally any pre-determined group of financial assets) as a medium of exchange. Similarly, the investment company 10 may transact with the underlying fund 20 in any of these media of exchange. When the medium of exchange is a pre-determined group of securities or other financial assets, the transactions are referred to as “in-kind” transactions. The medium of exchange may include both securities and money, in a so-called “hybrid” transaction. Such a hybrid transaction is appropriate when, for example, it would be impractical for the authorized participant to obtain a part of the requisite pre-determined group of financial assets because some such financial assets are in short supply. In this case, the authorized participant may replace the unavailable financial assets with an agreed upon amount of money. There are other situations in which hybrid transactions or transactions purely in money are appropriate and possible.

When transacting in-kind, non-fund securities are often traded with shares 16 of the underlying fund 20. In this context, the shares 16 are valued at their next-calculated NAV, and the non-fund securities are valued according to their fair market value (as determined by supply and demand) at the time of the transaction. For a given transaction, equal values of securities are exchanged, not necessarily equal shares.

In what follows, transactions are described between and among an authorized participant, the investment company 10, and its underlying fund 20. However, these descriptions should be understood to include transactions with agents or other entities acting on behalf of the authorized participant and/or the investment company 10 and/or the underlying fund 20.

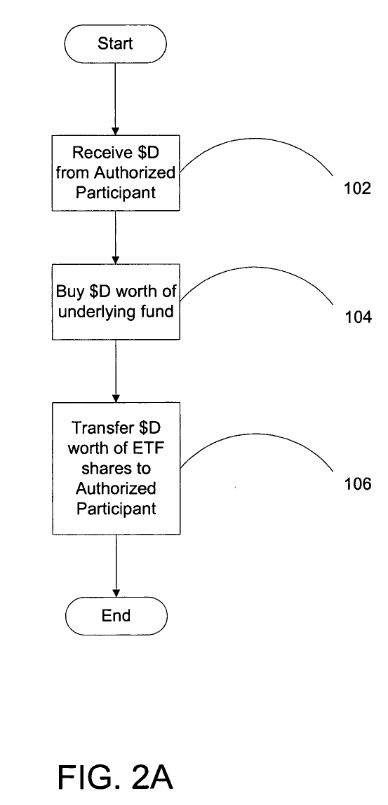

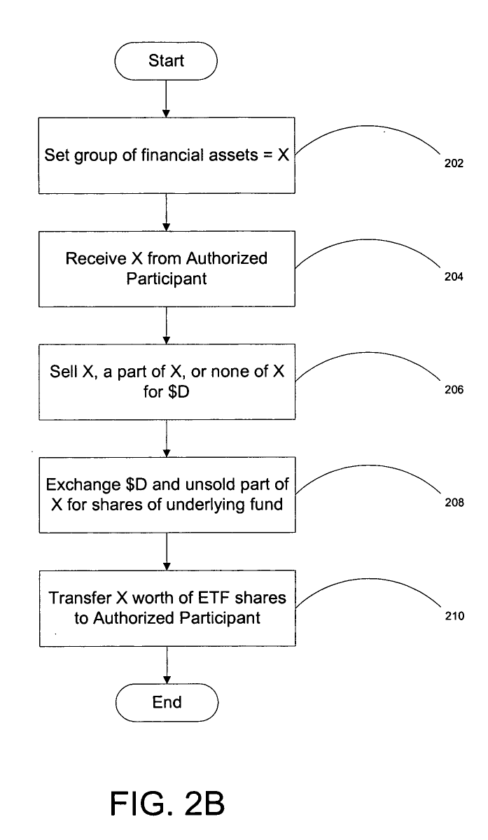

Referring to FIG. 2A, an authorized participant purchases ETF shares using money from the investment company 10 as follows. The investment company 10 receives 102 a sum of money, D dollars, from the authorized participant. The investment company buys 104 D dollars worth of shares 16 of its underlying fund. The investment company transfers 106 D dollars worth of ETF shares to the authorized participant.

These steps can be carried out in any order. The term “dollars” is used here and throughout this document as a label of convenience only; any form or forms of money may be used, including but not limited to any combination of U.S. dollars, Euros, and Yen. In an exemplary embodiment, these steps are all carried out within one business day. The term “business day” means the period of time between successive openings of the exchange on which the ETF is traded, excluding weekends and holidays during which the exchange is closed. For example, exchanges in the United States normally open at 9:30 a.m., Eastern Standard Time.

Referring to FIG. 2B, ETF shares may also be created by transacting in-kind. The investment company 10 first determines 202 a group of financial assets that serves as a medium of exchange. Equivalently, a third party can determine 202 a group of financial assets that the investment company 10 subsequently adopts as a medium of exchange. In FIG. 2B, this group of financial assets is denoted X. The group of financial assets may include any combination of money, securities, or other financial assets. The determination of the group need not include absolute amounts of any financial asset; merely fixing proportions of the financial assets will suffice.

The proportion may be a “share” proportion. For example, the investment company 10 may determine 202 that X is equal to Stock A and Stock B in a 1:2 proportion. Thus, 1 share of Stock A and 2 shares of Stock B can represent the group of financial assets, as can 100 shares of Stock A and 200 shares of Stock B. Alternatively, proportions of value could be specified, i.e. X may equal $1 worth of Stock A for every $2 worth of Stock B. The group of financial assets may be determined 202 in other ways.

In an exemplary embodiment, if the underlying fund 20 is an index fund, the group of financial assets is chosen to equal or economically represent the securities listed in the index, in the same or substantially the same proportions as they appear on the index, or in such proportions as they will perform (in the aggregate) in a highly correlated manner to the index. If the underlying fund 20 is an actively managed fund, the group of financial assets is chosen to be a group of securities economically corresponding to the funds' portfolio of securities 26. For example, the group of financial assets can be chosen so that net performance of the group corresponds to the net performance of the underlying fund's holdings, or to the net performance of the underlying fund itself. However, the group of financial assets is sufficiently distinct from the portfolio of securities 26 so that publicly describing the group of financial assets does not reveal the portfolio of securities 26. Revealing the securities in the portfolio 26 often constitutes a breach of management's fiduciary duty, and could adversely affect the fund's returns to investors. Additionally, the group of financial assets is typically determined anew every day.

Once a group of financial assets X is determined 202, the investment company 10 receives an amount of X from an authorized participant 204. The investment company may then sell 206 a portion of X for a certain amount of money, D dollars. All, none, or some of the group X may be sold. In an exemplary embodiment, none is sold (in which case D=0). The investment company 10 can then redeem 208 the unsold portion of X and the D dollars with its underlying fund 20 for a corresponding amount or value of shares 16 of its underlying fund 20. At any time during the above transactions, the investment company 10 may transfer 210 to the authorized participant a number of ETF shares corresponding to the size of X it received.

After an authorized participant has obtained a number of ETF shares and held them for a certain duration, the authorized participant may find it advantageous to redeem the ETF shares with the investment company 10. Typically, an authorized participant will hold the ETF shares for a duration at least equal to the interval between when the ETF shares were purchased and the underlying fund 20 recalculates its NAV. For redemption, the authorized participant may transact with the investment company 10 either on an in-kind basis or a money basis. Furthermore, the investment company 10 may interact with its underlying fund 20 either on an in-kind basis or a money basis. In each case, the redemption process is described below.

In what follows, the investment company 10 is necessarily holding a certain number of shares 16 of its underlying fund 20. This is because there are outstanding ETF shares held by an authorized participant. The shares were created as described above (see FIG. 2A or FIG. 2B), which necessarily results in the investment company 10 holding shares 16 of its underlying fund 20.

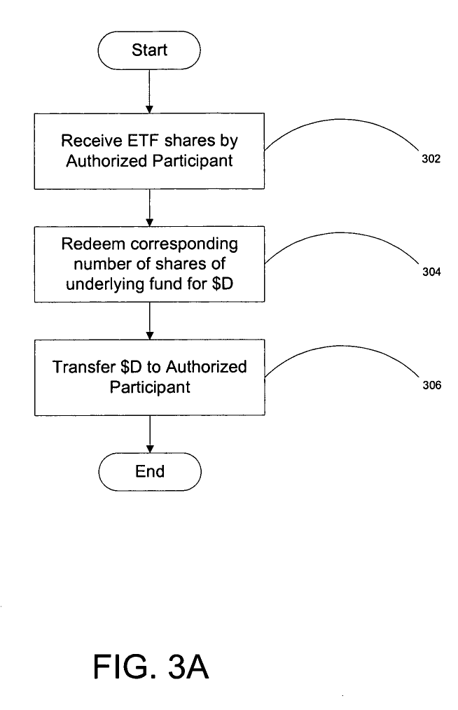

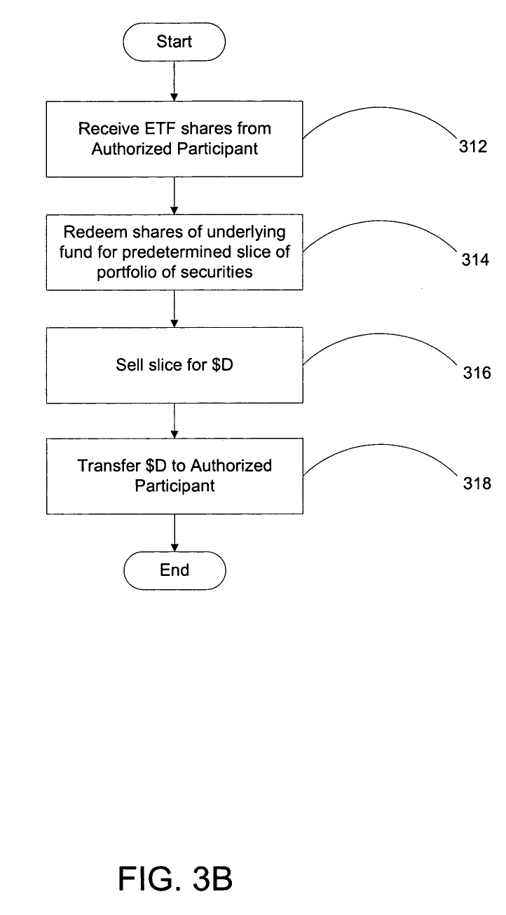

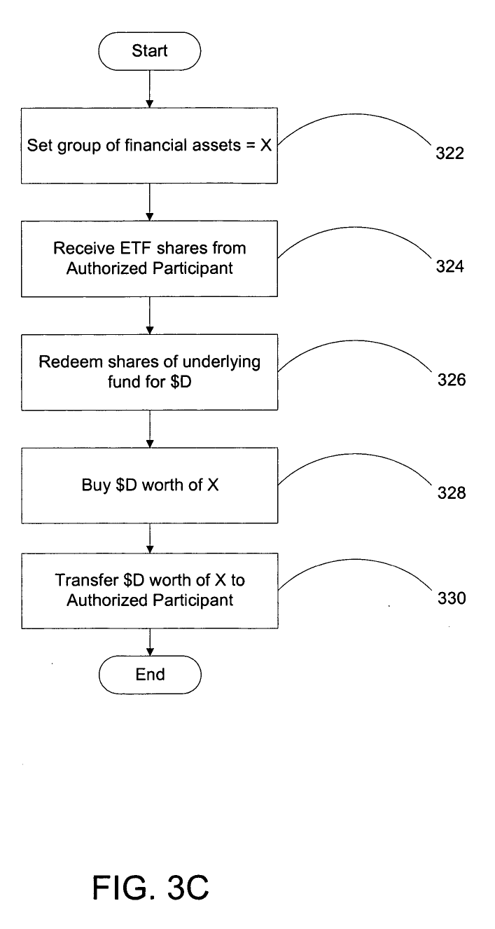

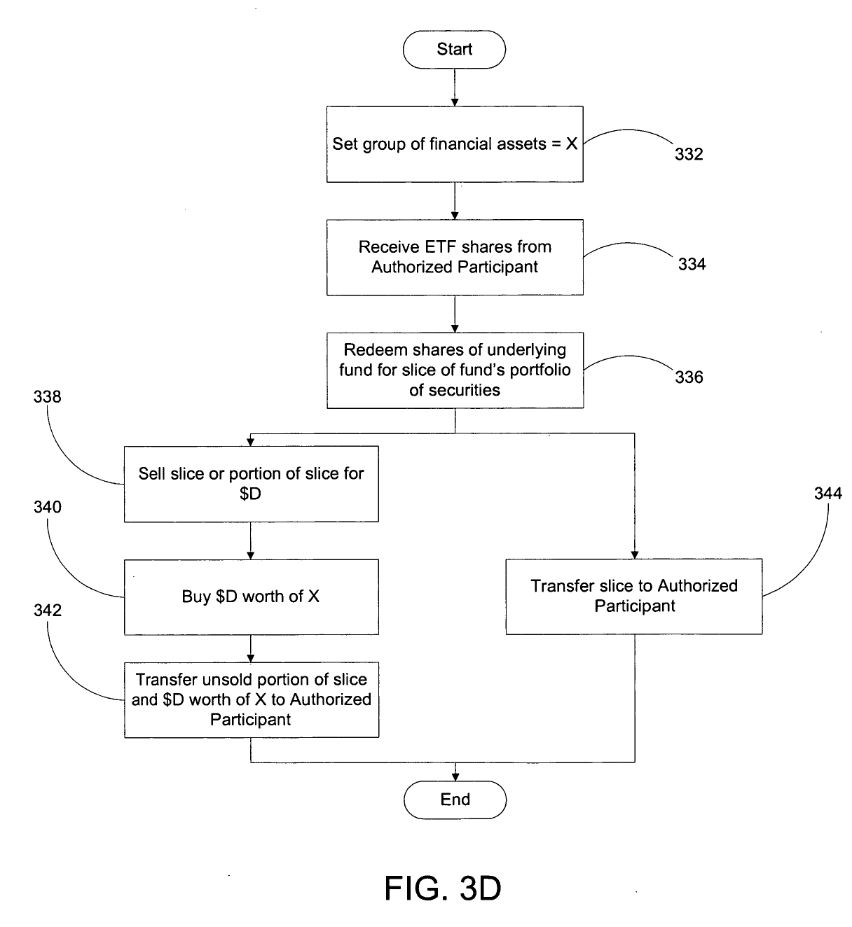

FIG. 3A shows an authorized participant redeeming ETF shares, when all transactions are money transactions. The investment company 10 receives 302 ETF shares from the authorized participant. The investment company 10 redeems 304 a corresponding number of shares 16 of the underlying fund, in exchange for D dollars, where D is determined by the next-calculated NAV of the fund. The investment company 10 transfers 306 D dollars to the authorized participant.

FIG. 3B shows an authorized participant redeeming ETF shares, when the authorized participant transacts with the investment company 10 in money, and the underlying fund 20 transacts with the investment company 10 on an in-kind basis. The investment company 10 receives 312 ETF shares from the authorized participant. The investment company 10 redeems 314 a corresponding number of shares 16 of the underlying fund 20 in exchange for a predetermined slice of the fund's portfolio of securities 26. The investment company 10 then sells 316 the securities, for example on a stock exchange, obtaining a price D dollars determined by the market value of the securities. The investment company 10 then transfers 318 D dollars to the authorized participant.

FIG. 3C shows an authorized participant redeeming ETF shares, when the authorized participant transacts with the investment company 10 on an in-kind basis, and the underlying fund 20 transacts with the investment company 10 in money. A group of financial assets X is determined 322. The investment company 10 receives 324 ETF shares from the authorized participant. The investment company 10 redeems 326 a corresponding number of shares 16 of the underlying fund, in exchange for D dollars. The investment company buys 328 D dollars worth of X, and transfers 330 this amount of X to the authorized participant.

FIG. 3D shows an authorized participant redeeming ETF shares, when the both the authorized participant and the underlying fund 20 transact with the investment company 10 on an in-kind basis. A group of financial assets X is determined 332. The investment company 10 receives 334 ETF shares from the authorized participant. The investment company 10 redeems 336 a corresponding number of shares 16 of the underlying fund 20 in exchange for a predetermined slice of the fund's portfolio of securities 26. If the slice of the portfolio of securities 26 is different from X, the slice is sold 338 for D dollars, and the investment company 10 buys 340 D dollars worth of X on a secondary market. Alternatively, if the slice of the portfolio of securities 26 overlaps with X, then optionally only the non-overlapping portion (if any) of the slice may be sold. In any case, an amount of X equal to the amount which the investment company 10 obtained (either directly from the underlying fund 20 or on a secondary market) is transferred 342 to the authorized participant. Another alternative is for the investment company 10 to transfer 344 the predetermined slice of the fund's portfolio of securities 26 to the authorized participant, notwithstanding any differences between X and the predetermined slice.

The transactions described in connection with FIGS. 3A-3D can be carried out in any order. In an exemplary embodiment, the transactions are all carried out within one business day.

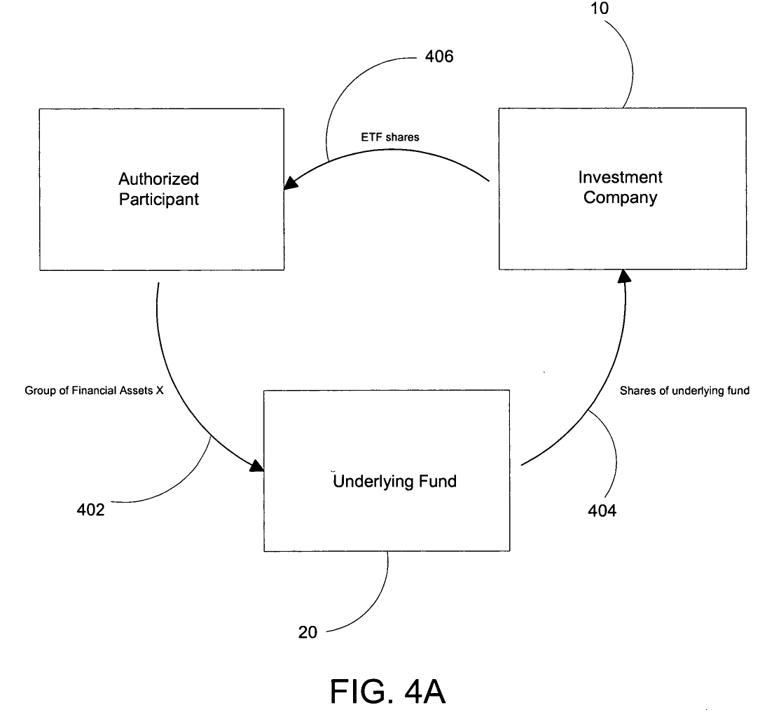

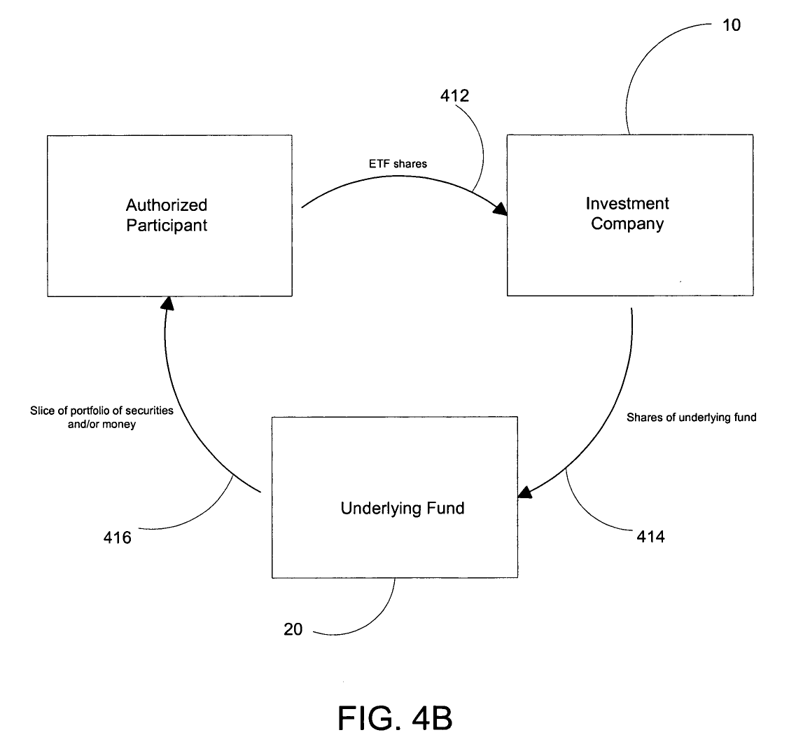

There are other ways for an authorized participant to purchase or redeem ETF shares. For example, ETF shares can be purchased or redeemed according to a “circular” arrangement shown in FIGS. 4A and 4B.

FIG. 4A shows an authorized participant purchasing ETF shares according to a circular arrangement. First, a group of financial assets (denoted X in FIG. 4A) is determined. As above, the group of financial assets may include money, securities, or other financial assets. The authorized participant transfers 402 a certain size group of X directly to the underlying fund 20. The underlying fund 20 then transfers 404 a corresponding number of fund shares 16 to the investment company 10. The correspondence is determined by the fair market value of X and the next-calculated NAV of the underlying fund 20. Finally, the investment company 10 transfers 406 a number of ETF shares to the authorized participant, with the number of ETF shares corresponding to the number of shares of the underlying fund received by the investment company.

FIG. 4B shows an authorized participant redeeming ETF shares according to the circular arrangement. In this context, it is assumed that the authorized participant is holding a certain number of ETF shares, and the investment company 10 is necessarily holding a certain number of shares 16 of its underlying fund 20.

First, the authorized participant transfers 412 a desired number of ETF shares to the investment company 10. Then, the investment company 10 redeems 414 a corresponding number of shares 16 with its underlying fund 20. Finally, the underlying fund 20 transfers 416 either a predetermined slice of its portfolio of securities 26, or an amount of money, or a combination of both, to the authorized participant. The total value of the securities or money transferred to the authorized participant is determined by the number of shares 16 redeemed with the underlying fund 20, and the next-calculated NAV of the fund after the shares are redeemed.

The steps described in reference to either FIG. 4A or FIG. 4B could be performed in any order.

Purchasing or redeeming ETF shares as described above allows the preferred medium of exchange between an authorized participant and the investment company 10 to be defined independently of the preferred medium of exchange between the investment company 10 and the underlying fund 20. One context in which this is advantageous is when the underlying fund 20 is an actively managed fund. In this context, the management of the underlying fund may determine at a particular time that it is in the best interest of the fund to only transact using a certain medium of exchange, e.g. money. If an authorized participant finds this medium of exchange inconvenient or undesirable, the authorized participant is less likely to purchase or redeem ETF shares at that time. However, when ETF shares are purchased or redeemed as described above, the investment company 10 can determine a medium of exchange (in particular, a medium more agreeable to authorized participants) for transacting with authorized participants. This determination is independent of any preferred medium of exchange for transactions with the underlying fund 20.

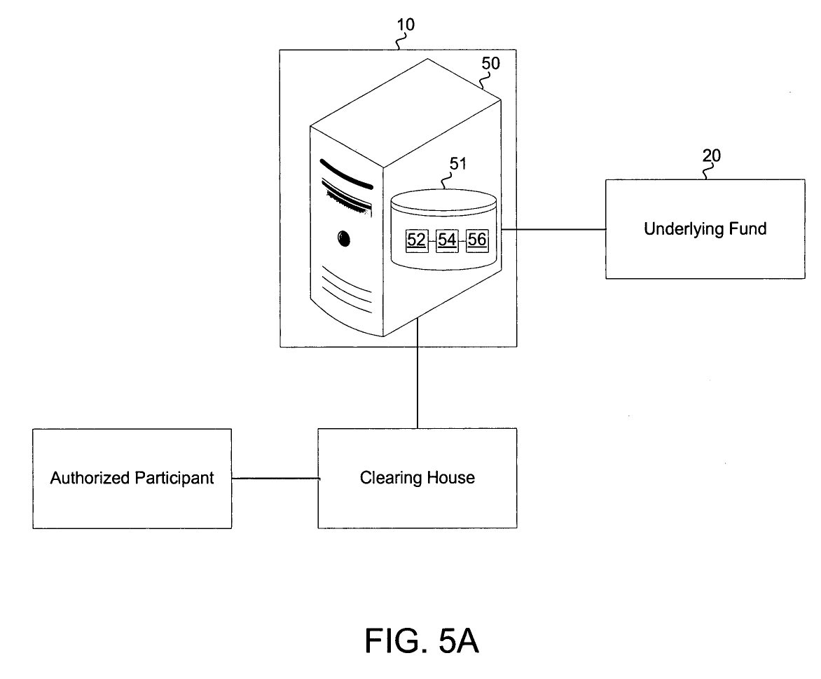

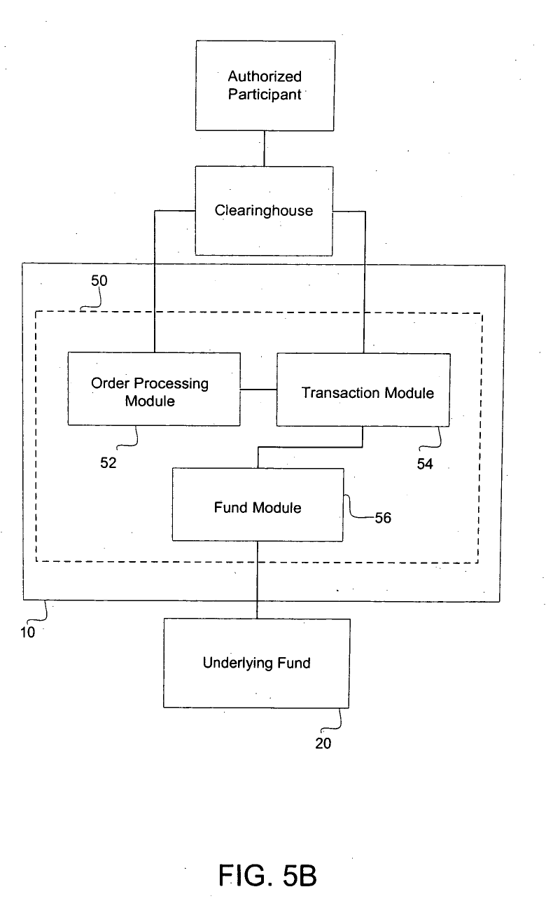

Referring to FIG. 5A, a system for handling the above transactions is shown. The system 50 includes a storage medium 51 such as a hard disk drive, static or non-static memory, an optical disk, etc. The storage medium 51 contains an order-processing module 52, a transaction module 54, and a fund module 56. These modules may be implemented, for example, as programs running on a computer or as programs running on different computers. When communication between the modules or with other entities is required, such communication is implemented in any suitable way. For example, communication may be implemented by telephone, local area network (LAN), wide area network (WAN), the internet, or in other ways. Although the system 50 is depicted as a single computer in FIG. 5A, a combination of computers, storage media, network connections, and/or processors may be used.

Referring to FIG. 5B, the order-processing module 52 accepts requests to sell or purchase ETF shares made by an authorized participant, for example using a web-based interface. Typically, the requests are sent to the order-processing module 52 via a clearinghouse such as the Depositary Trust Company. One implementation of the order-processing module 52 is described in pending U.S. patent application Ser. No. 11/232,571 entitled “DATA PROCESSING FOR AN EXCHANGE TRADED FUND,” the entirety of which is incorporated by reference herein. The order-processing module 52 checks the order for accuracy and completeness. Such checks include verification that: the requesting party is in fact an authorized participant; the syntax of the order is proper; the volume of the transaction is a whole number of creation units, etc. If the order fails any of these checks, the order-processing module 52 posts an error.

Otherwise, the order-processing module 52 passes the request to the transaction module 54. The transaction module 54 records the ETF shares issued by the investment company 10, instructs the clearinghouse to settle the shares in the authorized participant's account, and generates a purchase or sale order to underlying fund 20 for a number of fund shares 16 corresponding to the value of the creation unit order. For example, the transaction module can generate a purchase order corresponding to step 104 in FIG. 2A, if the authorized participant is purchasing ETF shares with money. The purchase or sale order is typically sent to the transfer agent of the underlying fund 20. Generally, the transfer agent of a fund is an entity responsible for: managing transactions between the shareholders of record and the fund; or acting as an agent for beneficial owners of the fund in transactions with other entities.

The transaction module 54 also sends a purchase or sale order to the investment company 10 to record the investment company's transaction with the underlying fund 20. This purchase or sale order is typically sent to the trading system of the investment company 10 (not shown). Generally, the trading system of an investment company is a system for managing financial information about (or information known by) the investment company relating to securities transactions.

The fund module 56 receives information from the underlying fund 20 concerning the fund's currently preferred medium of exchange (money, in-kind, hybrid, etc.). Based on this information, the fund module 56 determines or updates the investment company's desired medium of exchange. For example, if the underlying fund 20 prefers to transact in a particular stock or group of stocks, the fund module 56 may set the desired medium of exchange for purchasing or selling ETF shares to be the same stock or group of stocks. Alternatively, if the underlying fund 20 prefers to transact in a group of stocks, the fund module 56 may set the desired medium of exchange for purchasing or selling ETF shares to be the same group of stocks with certain modifications based on external circumstances (e.g., one stock of the group is in short supply).

If the investment company 10 and the underlying fund 20 prefer to transact in different groups of financial assets, the fund module 56 facilitates transactions by “converting” one group of financial assets to the other in a given transaction. (See, e.g., steps 336 to 342 in FIG. 3D). For example, suppose the investment company 10 prefers to transact in stocks A, B, and C (in equal value proportions), while the underlying fund 20 prefers to transact in stocks A, B, and D (in equal value proportions). When an authorized participant tenders ETF shares to the investment company 10, the investment company 10 will redeem a corresponding number of fund shares 16 with the underlying fund 20. The investment company will receive a bundle of stock containing equal values of stocks A, B, and D. The fund module 56 will sell stock D, and buy stock C. The investment company 10 is now holding a bundle of stocks according to its preferred medium of exchange to be transfer to the authorized participant in exchange for the ETF shares originally tendered.

Other embodiments are within the scope of the following claims:

What is claimed is:

1. A method for selling ETF shares comprising:
receiving, by an investment company, a predetermined group of financial assets from an authorized participant in exchange for a number of ETF shares, the number of ETF shares corresponding to the group of financial assets;
purchasing a number of shares of an underlying fund, the number of shares corresponding to the group of financial assets.

2. The method of claim 1, wherein the group of financial assets includes currency.

3. The method of claim 1, wherein the group of financial assets includes securities.

4. The method of claim 3, further comprising selling the group of financial assets for currency, wherein the number of shares of the underlying fund is purchased with the currency.

5. The method of claim 3, wherein the underlying fund includes holdings, and the securities are determined to correspond to the underlying fund's holdings.

6. The method of claim 3, wherein the underlying fund includes holdings having a net performance over a defined period, and the securities are chosen to correspond to the fund's holdings' net performance over the defined period.

7. The method of claim 3, wherein the underlying fund has a net performance over a defined period, and the securities are chosen to correspond to the fund's net performance over the defined period.

8. The method of claim 1, wherein the investment company is a unit investment trust.

9. The method of claim 1, wherein the investment company is a management investment company.

10. The method of claim 1, wherein the investment company is a face-amount certificate company.

11. The method of claim 1, wherein the fund is actively managed.

12. The method of claim 1, wherein the fund is an index fund.

13. The method of claim 1, wherein the fund is open-ended.

14. The method of claim 1, wherein the fund is closed-ended.

15. The method of claim 1, wherein the method is performed in at most one business day.

16. A method of redeeming ETF shares comprising:
receiving, by an investment company holding a number of shares of an underlying fund, ETF shares from an authorized participant;
redeeming the number of shares of the underlying fund for a first group of financial assets;
obtaining a second group of financial assets; and
transferring the second group of financial assets to the authorized participant.

17. The method of claim 16, wherein the first group of financial assets includes currency.

18. The method of claim 16, wherein the first group of financial assets includes securities.

19. The method of claim 16, wherein the second group of financial assets includes currency.

20. The method of claim 16, wherein the second group of financial assets includes securities.

21. The method of claim 18, wherein obtaining the second group of financial assets comprises purchasing the securities with a quantity of currency obtained from the first group of financial assets.

22. The method of claim 18, wherein the fund includes holdings, and the securities in the second group of financial assets correspond to the fund's holdings.

23. The method of claim 18, wherein the fund includes holdings having a net performance, and the securities in the second group of financial assets correspond to the fund's holdings' net performance.

24. The method of claim 16, wherein the investment company is a unit investment trust.

25. The method of claim 16, wherein the investment company is a management investment company.

26. The method of claim 16, wherein the investment company is a face-amount certificate company.

27. The method of claim 16, wherein the fund is actively managed.

28. The method of claim 16, wherein the fund is an index fund.

29. The method of claim 16, wherein the fund is open-ended.

30. The method of claim 16, wherein the fund is closed-ended.

31. The method of claim 16, wherein the method is performed in at most one business day.

32. A method of selling ETF shares comprising:
transferring, from an investment company, a number of ETF shares to an authorized participant in response to receiving a number of shares of an underlying fund from the underlying fund,
wherein the underlying fund transfers the number of shares to the investment company in response to the authorized participant transferring a group of financial assets to the underlying fund.

33. A method of redeeming ETF shares comprising:
redeeming a number of shares of an underlying fund held by an investment company in response to receiving, by the investment company, a number of ETF shares from an authorized participant,
wherein the underlying fund transfers a group of financial assets to the authorized participant in response to the investment company redeeming shares of the underlying fund.

34. A medium bearing instructions to cause a computer to:
receive, by an investment company, a pre-determined group of financial assets from an authorized participant in exchange for a number of ETF shares, the number of ETF shares corresponding to the group of financial assets;
purchase a number of shares of an underlying fund, the number of shares corresponding to the group of financial assets.

35. The medium of claim 34, wherein the group of financial assets includes currency.

36. The medium of claim 34, wherein the group of financial assets includes securities.

37. The medium of claim 36, further comprising instructions to cause a computer to sell the group of financial assets for currency, wherein the number of shares of the underlying fund is purchased with the currency.

38. The medium of claim 36, wherein the underlying fund includes holdings, and the securities are determined to correspond to the underlying fund's holdings.

39. The medium of claim 36, wherein the underlying fund includes holdings having a net performance over a defined period, and the securities are chosen to correspond to the fund's holdings' net performance over the defined period.

40. The medium of claim 36, wherein the underlying fund has a net performance over a defined period, and the securities are chosen to correspond to the fund's net performance over the defined period.

41. The medium of claim 34, wherein the investment company is a unit investment trust.

42. The medium of claim 34, wherein the investment company is a management investment company.

43. The medium of claim 34, wherein the investment company is a face-amount certificate company.

44. The medium of claim 34, wherein the fund is actively managed.

45. The medium of claim 34, wherein the fund is an index fund.

46. The medium of claim 34, wherein the fund is open-ended.

47. The medium of claim 34, wherein the fund is closed-ended.

48. The medium of claim 34, wherein the instructions borne on the medium are performed in at most one business day.

49. A medium bearing instructions to cause a computer to:
receive, by an investment company holding a number of shares of an underlying fund, ETF shares from an authorized participant;
redeem the number of shares of the underlying fund for a first group of financial assets;
obtain a second group of financial assets; and
transfer the second group of financial assets to the authorized participant.

50. The medium of claim 49, wherein the first group of financial assets includes currency.

51. The medium of claim 49, wherein the first group of financial assets includes securities.

52. The medium of claim 49, wherein the second group of financial assets includes currency.

53. The medium of claim 49, wherein the second group of financial assets includes securities.

54. The medium of claim 53, wherein obtaining the second group of financial assets comprises purchasing the securities with a quantity of currency obtained from the first group of financial assets.

55. The medium of claim 53, wherein the fund includes holdings, and the securities in the second group of financial assets correspond to the fund's holdings.

56. The medium of claim 53, wherein the fund includes holdings having a net performance, and the securities in the second group of financial assets correspond to the fund's holdings' net performance.

57. The medium of claim 49, wherein the investment company is a unit investment trust.

58. The medium of claim 49, wherein the investment company is a management investment company.

59. The medium of claim 49, wherein the investment company is a face-amount certificate company.

60. The medium of claim 49, wherein the fund is actively managed.

61. The medium of claim 49, wherein the fund is an index fund.

62. The medium of claim 49, wherein the fund is open-ended.

63. The medium of claim 49, wherein the fund is closed-ended.

64. The medium of claim 49, wherein the instructions borne by the medium are performed in at most one business day.

65. A medium bearing instructions to cause a computer to:
transfer, from an investment company, a number of ETF shares to an authorized participant in response to receiving a number of shares of an underlying fund from the underlying fund,
wherein the underlying fund transfers the number of shares to the investment company in response to the authorized participant transferring a group of financial assets to the underlying fund.

66. A medium bearing instructions to cause a computer to:
redeem a number of shares of an underlying fund held by an investment company in response to receiving, by the investment company, a number of ETF shares from an authorized participant,
wherein the underlying fund transfers a group of financial assets to the authorized participant in response to the investment company redeeming shares of the underlying fund.
